(19) United States
(12) Patent Application Publication
(10) Pub. No.: US 2026/0230768 A1
(43) Pub. Date: Aug. 6, 2026

(54) METHOD FOR CALIBRATING A VEHICLE AUDIO SYSTEM OF A VEHICLE

(71) Applicants: Ningbo Geely Automobile Research & Development Co., Ltd., Ningbo (CN); Zhejiang Geely Holding Group Co., Ltd., Zhejiang (CN)

(72) Inventor: Sergejs DOMBROVSKIS, Hisings Backa (SE)

(21) Appl. No.: 19/637,815

(22) Filed: Apr. 2, 2026

Related U.S. Application Data
(63) Continuation of application No. PCT/CN2024/119807, filed on Sep. 19, 2024.

(30) Foreign Application Priority Data
Oct. 4, 2023 (EP) 23201565

(51) Int. Cl. H04S 7/00; B60N 2/90; B60R 11/00; B60R 11/02; H04R 1/08; H04S 1/00; H04S 3/00

(52) U.S. Cl. CPC H04S 7/301; B60N 2/90; B60R 11/0217; B60R 11/0247; B60R 2011/0012; H04R 1/08; H04R 2499/13; H04S 1/007; H04S 3/008; H04S 2400/01

(57) ABSTRACT

A method for calibrating a vehicle audio system of a vehicle, the audio system having loudspeakers; a power-adjustable vehicle seat including a seat cushion, a seat backrest, a seat headrest, a microphone integrated in the seat headrest or upper region of the backrest, and at least one powered seat position actuator for enabling adjustment of the vehicle seat position; and a control system configured for controlling operation of the powered seat position actuator. The method includes: controlling the at least one powered seat position actuator to move the microphone of the vehicle seat to a plurality of different spatial positions, and registering, at each of said different spatial positions, microphone data received from the microphone while generating a calibration sound by means of a loudspeaker of the vehicle audio system; and calibrating the vehicle audio system based on the registered microphone data.

### RELATED APPLICATION DATA

This application is a continuation of International Patent Application No. PCT/CN2024/119807, filed Sep. 19, 2024, and claims the benefit of European Patent Application No. 23201565 , filed Oct. 4, 2023, the disclosures of which are incorporated herein by reference in their entireties.

### TECHNICAL FIELD

The present disclosure relates to a method for calibrating a vehicle audio system of a vehicle, as well as a corresponding vehicle system.

The method for calibrating a vehicle audio system, and associated system, will be described primarily in relation to a car. However, the method and system are not restricted to this particular vehicle but may as well be installed or implemented in another type of vehicle, such as a truck, a bus, a flying vehicle, a marine vessel, a working vehicle or the like.

### BACKGROUND

In the field of vehicle audio systems, there is an increasing demand for providing a high vehicle audio sound quality, especially in view of the reduced powertrain noise associated with electrical vehicles.

However, vehicle cabin interior is a generally a very complex acoustic environment with a lot of nearby walls, roof, windscreen and windows that cause reflections, combined with seats that absorb some part of the sound.

In addition, strongly varying vehicle cabin temperatures over the year causes accelerated aging of the loudspeakers.

Consequently, merely installing a standard audio equipment in a vehicle may provide low sound quality.

A known solution for improving audio sound quality is to make an extensive audio sound testing of test vehicle, such as a golden sample vehicle, during the vehicle development phase. Such audio sound testing may for example involve temporarily installing a measurement microphone within the driver cabin and registering the sound profile while playing a calibration sound on the existing vehicle audio system.

However, although this audio sound testing may result in improved sound quality, there is still a need for a further improved method and system for calibrating the audio system, in particular a method and system that provides further improved audio sound quality.

### SUMMARY

Due to the rather small interior cabin space of vehicles in general, small shifts in head position of a user located in a vehicle seat may result in large changes of sound pressure levels, for example due to cancellation or superposition of sound waves having different origin and/or reflection paths. In other words, the perceived sound level from individual speaker may be more than two times louder or quieter than intended, depending on body posture, seating position, etc.

In addition, there is a significant variance in actual speaker element specifications due to manufacturing tolerances but also due to aging and climate effects.

The solution according to the disclosure involves implementing tuning or calibration of the vehicle audio system by generating a tuning or calibration sound by a loudspeaker while registering the tuning or calibration sound by means of a microphone. Thereby, the signal of each output channel of the vehicle audio system may be individually calibrated for providing a balanced and high quality sound.

However, using an external microphone that is temporarily mounted in a test vehicle during the vehicle development phase for performing said tuning or calibration have several disadvantages. For example, the tuning or calibration is time consuming because microphone data at each of a large set of microphone positions must be registered to enable audio system tuning at all seat positions. In addition, the microphone data registration process is typically performed only once on a pre-production test vehicle and does not take loudspeaker aging or vehicle and/or loudspeaker individual characteristic into account.

Furthermore, performing vehicle audio tuning or calibration based on microphone data from a microphone mounted on the seat or other points of the interior may also provide poor sound quality, because of a significant divergence between the registered microphone data and the sound that a user hears due to potentially large change in sound levels when the user's ear is located displaced a small amount from the location of the microphone.

Consequently, an object of the present disclosure is to provide a method for calibrating a vehicle audio system of a vehicle, and corresponding vehicle system, where the previously mentioned problems are avoided.

Specifically, according to a first aspect of the present disclosure, there is provided a method for calibrating an audio system of a vehicle, wherein the vehicle comprises: an audio system having a set of loudspeakers; a power-adjustable vehicle seat including a seat cushion, a seat backrest, a seat headrest, at least one microphone integrated in the seat headrest or upper region of the backrest, and at least one powered seat position actuator for enabling adjustment of the vehicle seat position; and a control system configured for controlling operation of the powered seat position actuator; the method comprising: controlling the at least one powered seat position actuator, by the control system, for moving the at least one microphone of the vehicle seat to a plurality of different spatial positions, and registering, at each of said different spatial positions, microphone data received from the at least one microphone while generating a calibration sound by means of a loudspeaker of the vehicle audio system; and calibrating the vehicle audio system based on the registered microphone data received from the at least one microphone.

In addition, according to a second aspect of the present disclosure, there is provided a vehicle system comprising: an audio system having a set of loudspeakers; a power-adjustable vehicle seat including a seat cushion, a seat backrest, a seat headrest, at least one microphone integrated in the seat headrest or upper region of the backrest, and at least one powered seat position actuator for enabling adjustment of the vehicle seat position; and a control system configured for controlling operation of the powered seat position actuator; wherein the control system is configured for: controlling the at least one powered seat position actuator, by the control system, for moving the at least one microphone of the vehicle seat to a plurality of different spatial positions, and registering, at each of said different spatial positions, microphone data received from the at least one microphone while generating a calibration sound by means of a loudspeaker of the vehicle audio system; and calibrating the vehicle audio system based on the registered microphone data received from the at least one microphone.

In this way, it becomes possible to accomplish improved vehicle audio system calibration in terms of improved sound quality, because during the calibration sound registration the microphone may be located closer to the actual ear position of the user during subsequent use of the vehicle, and the calibration process will deliver unique audio system tuning for each individual vehicle, and take the individual loudspeaker and/or vehicle characteristics into account.

Moreover, the calibration process may be easily repeated over time for taking aging of loudspeaker and/or audio electronic equipment into account, as well as changes in vehicle cabin interiors.

In addition, the automatic movement of the seat for moving the integrated microphones to a plurality of spatial positions during the calibration process and taking calibration measurements from each of these spatial positions into account during the calibration process, reduces the potential risk that a single measurement location provides a poor calibration setting that delivers sound quality, for example due to interior cabin sound effects at this particular position.

In some example embodiments, that may be combined with any one or more of the above-described embodiments, the power-adjustable vehicle seat includes at least two microphones, wherein a first microphone of said at least two microphones is integrated in a left side region of the seat headrest or upper left side region of backrest, and wherein a second microphone of said at least two microphones is integrated in a right side region of the headrest or upper right side region of backrest, wherein the step of controlling the at least one powered seat position actuator involves controlling the at least one powered seat position actuator for moving each of said first and second microphones of the vehicle seat to a plurality of different spatial positions, wherein the step of registering microphone data involves registering, at each of said different spatial positions, microphone data received from each of said first and second microphones while generating a calibration sound by means of a loudspeaker of the vehicle audio system, and wherein the step of calibrating the vehicle audio system involves calibrating the vehicle audio system based on the registered microphone data received from each of the first and second microphones. By having two microphones, these can be mounted and located more closely to each ear of the user, and thereby providing a more relevant microphone measurement data. In addition, the left and right location of the two microphones enables each microphone to be more sensitive to individual left and right sound characteristics of the seat, and thereby enabling improved calibration result.

In some example embodiments, that may be combined with any one or more of the above-described embodiments, the step of controlling the at least one powered seat position actuator involves controlling the at least one powered seat position actuator for moving the at least one microphone of the vehicle seat to a at least four different spatial positions, wherein the step of registering microphone data involves registering, at each of said at least four different spatial positions, microphone data received from the at least one microphone while generating a calibration sound by means of a loudspeaker of the vehicle audio system, wherein the step of calibrating the vehicle audio system involves calibrating the vehicle audio system based on the registered microphone data received from each of said at least four different spatial positions. An increased number of locally distributed spatial positions for registering calibration sound in the region of the ear of the user enables improved calibration, because the detrimental effect of a single measurement errors and/or undesirable sound conditions at an individual spatial position may be reduced.

In some example embodiments, that may be combined with any one or more of the above-described embodiments, the step of controlling the at least one powered seat position actuator involves controlling the at least one powered seat position actuator for moving each of said first and second microphones of the vehicle seat to a at least four different spatial positions, and wherein the step of registering microphone data involves registering, at each of said at least four different spatial positions, microphone data received from each of said first and second microphones while generating a calibration sound by means of a loudspeaker of the vehicle audio system. Thereby, increased amount of relevant microphone measurements data is obtained, such that an improved calibration result is enabled.

In some example embodiments, that may be combined with any one or more of the above-described embodiments, the audio system includes a power amplifier having at least a first output channel and a second output channel, and a first loudspeaker connected to the first output channel and a second loudspeaker connected to the second output channel, wherein the step of registering microphone data involves registering, at each of said different spatial positions, microphone data received from the at least one microphone while generating a calibration sound by means of the first loudspeaker individually and while generating a calibration sound by means of the second loudspeaker individually. Thereby, the individual characteristic of each output channel and each loudspeaker can be taken into account when performing the audio system calibration.

In some example embodiments, that may be combined with any one or more of the above-described embodiments, the audio system includes a power amplifier having at least a first output channel and a second output channel, and a first loudspeaker connected to the first output channel and a second loudspeaker connected to the second output channel, wherein the step of controlling the at least one powered seat position actuator involves controlling the at least one powered seat position actuator for moving each of said first and second microphones of the vehicle seat to a at least four different spatial positions, and wherein the step of registering microphone data involves registering, at each of said at least four different spatial positions, microphone data received from each of said first and second microphones while generating a calibration sound by means of the first loudspeaker individually and while generating a calibration sound by means of the second loudspeaker individually. This enables improved calibration result by increased microphone measurement data and individual loudspeaker calibration sound generation.

In some example embodiments, that may be combined with any one or more of the above-described embodiments, the power-adjustable vehicle seat includes at least two powered seat position actuators, of which a first powered seat position actuator is configured for enabling adjustment of a longitudinal and/or vertical position of the seat cushion of the vehicle seat, and a second powered seat position actuator is configured for enabling adjustment of an angular position of the seat backrest of the vehicle seat; wherein the step of controlling the at least one powered seat position actuator involves controlling the at least first and second powered seat position actuators for moving each of said first and second microphones of the vehicle seat to a at least four different spatial positions, wherein the step of registering microphone data involves registering, at each of said at least four different spatial positions, microphone data received from each of said first and second microphones while generating a calibration sound by means of the first loudspeaker individually and while generating a calibration sound by means of the second loudspeaker individually.

In some example embodiments, that may be combined with any one or more of the above-described embodiments, the step of calibrating the vehicle audio system involves calibrating the vehicle audio system based on the registered microphone data received from each of said plurality of different spatial positions, wherein a relevance of said registered microphone data received from each of said plurality of different spatial positions are weighted differently when calibrating the vehicle audio system based on said registered microphone data. Thereby, the significance of registered microphone measurement data from each spatial position can be individually assessed and taken into account during the calibration process.

In some example embodiments, that may be combined with any one or more of the above-described embodiments, the relevance of said registered microphone data received from each of said plurality of different spatial positions is weighted as a function of closeness of each of said plurality of different spatial positions, to a registered or estimated position of an ear of user when seated in the vehicle seat. This means that the microphone measurement data from spatial positions located close to the estimated/registered ear position of the user can be assessed as being more relevant than microphone measurement data from spatial positions located further away from the estimated/registered ear position, such that an improved calibration result may be accomplished.

In some example embodiments, that may be combined with any one or more of the above-described embodiments, the method further comprises an initial step of obtaining instructions or determining need for performing a calibrating of the vehicle audio system, and in response thereto, initialising said steps of moving the at least one microphone of the vehicle seat to a plurality of different spatial positions and registering, at each of said different spatial positions, microphone data while generating a calibration sound by means of a loudspeaker. The user of the vehicle may thus initiate a calibration process at any time, for example in response to a perceived degraded sound quality, or for performing a diagnosis of the audio system in case a malfunction of any part of the audio system is suspected, and the user is not dependent on an another party for performing the calibration. This provides the user with greater flexibility and freedom of choice.

In some example embodiments, that may be combined with any one or more of the above-described embodiments, the method further comprises performing a warm-up sequence and/or a temperature equalization sequence of the one or more loudspeakers of the audio system that will be generating a calibration sound during registration of microphone data at each of said different spatial positions. Thereby, it can be ensured that the calibration result is valid for normal operating conditions of the audio system.

In some example embodiments, that may be combined with any one or more of the above-described embodiments, the control of the at least one powered seat position actuator, for moving the at least one microphone of the vehicle seat to a plurality of different spatial positions, is based on at least one of the following parameters: position setting of the vehicle seat, position setting of the steering wheel, registered or estimated body length of a user, registered or estimated ear position of a user when seated in the vehicle seat. Seat and/or steering wheel settings is easily and cost-effectively obtained data in a vehicle and provides relatively accurate estimated of the ear positions of a user when seated in the seat.

In some example embodiments, that may be combined with any one or more of the above-described embodiments, the at least one powered seat position actuator is controlled, such that said plurality of different spatial positions, at which microphone data received from the at least one microphone is registered, are located as close as possible to, or overlapping, a registered or estimated position of an ear of user when seated in the vehicle seat, as viewed in a vehicle lateral direction. By selecting spatial positions located as close as possible to the ear of the user, when seated in the seat, the relevance of the microphone measurement data is improved.

In some example embodiments, that may be combined with any one or more of the above-described embodiments, said different spatial positions, at which microphone data received from the at least one microphone are registered, define a measurement area that is smaller than 50%, specifically smaller than 25%, more specifically smaller than 10%, of a maximal area reachable by said at least one microphone by control of the at least one powered seat position actuator, as viewed in a vehicle lateral direction. By selecting a relatively small set of a different spatial position for the microphone data measurements, such as for example in the range of 3-10 different locations, that are located densely in a relevant measurement area, i.e. close or overlapping with ear position, the obtained measurement data is relevant for the specific user of the vehicle and enables good calibration result, while avoiding a very long calibration process typically associated with a calibration process that takes a large fixed and predetermined measurement area into account.

In some example embodiments, that may be combined with any one or more of the above-described embodiments, the control system is configured to perform the calibration process of the vehicle audio system, including the motion of the at least one microphone of the vehicle seat to a plurality of different spatial positions and registering of microphone data received from the at least one microphone, automatically. Thereby, the user does not need to take an active part in the calibration process, which may be convenient for the user, and the calibration result is also generally better and more reliable.

In some example embodiments, that may be combined with any one or more of the above-described embodiments, the method further comprising controlling the at least one powered seat position actuator, by the control system, for returning the seat to the position the seat had prior to start of the calibration process. Thereby, the user does not to manually return the seat to the previous seat position.

In some example embodiments, that may be combined with any one or more of the above-described embodiments, the control system is configured to perform the calibration process of the vehicle audio system, including the motion of the at least one microphone of the vehicle seat to a plurality of different spatial positions and registering of microphone data received from the at least one microphone, when the vehicle is empty of users and the vehicle doors and windows are closed. Thereby, undesirable interface from the user and from noise coming from outside of the vehicle is reduced, the loudspeakers in the door are located at the correct positions, and the sound wave reflections against the windows is taken into account in the calibration process.

In some example embodiments, that may be combined with any one or more of the above-described embodiments, the control system may perform quality checks of the registered microphone data received from the at least one microphone during the calibration process, and to interrupt the calibration process if the registered microphone data indicates interference of some kind, such as too much background noise, or the like.

In some example embodiments, that may be combined with any one or more of the above-described embodiments, the control system is configured to, prior to initialising said steps of moving the at least one microphone of the vehicle seat to a plurality of different spatial positions and registering, at each of said different spatial positions, microphone data while generating a calibration sound by means of a loudspeaker, requesting the user to leave the vehicle. Thereby it is avoided that the user is surprised by the sudden automatic movement of the seat during the calibration process, and any undesirable interface from the user during calibration is avoided.

In some example embodiments, that may be combined with any one or more of the above-described embodiments, the step of calibrating a vehicle audio system based on the registered microphone data received from the at least one microphone involves: analysing the received microphone data received from the at least one microphone; and determining and applying a tuning profile to the signal of at least one output channel of the vehicle audio system. Thereby, the sound profile of each loudspeaker may be calibrated for optimal sound for the user when seated in the seat.

In some example embodiments, that may be combined with any one or more of the above-described embodiments, the control system additionally enables the user to perform manual tuning, e.g. applying a manual tuning profile, target curve, offsets, or the like, for enhancing the tuning provided by the automatic calibration method of the present disclosure.

In some example embodiments, that may be combined with any one or more of the above-described embodiments, the step of analysing the received microphone data received from the at least one microphone involves applying a correction for eliminating or at least reducing the acoustical effects caused by having the at least one microphone embedded into the seat. In some example embodiments, the at least one microphone is not only integrated in seat, but also invisibly embedded within the seat, for example under an outer textile cover sheet of the seat. In such case, the textile cover sheet may influence the registered calibration sound, and a correction of the register calibration sound may be necessary for avoiding the interference caused by the textile cover sheet.

In some example embodiments, that may be combined with any one or more of the above-described embodiments, the generated calibration sound by means of a loudspeaker of the vehicle audio system is pink noise, logarithmic sweep, white noise signal or other audio content suitable for the analysis of registered audio spectrum. Thereby, the registered microphone data will be of high-quality input for subsequent sound analysis and calibration.

In some example embodiments, that may be combined with any one or more of the above-described embodiments, the method may comprise an initial step of controlling the at least one powered seat position actuator, by the control system, for moving the at least one microphone of the vehicle seat to a plurality of different spatial positions covering a major portion of all conceivable seat positions, and registering, at each of said different spatial positions, microphone data received from the at least one microphone while generating a calibration sound by means of a loudspeaker of the vehicle audio system; and upon obtaining instructions or determining need for performing a calibrating of the vehicle audio system, performing the calibrating of the vehicle audio system based on microphone data registered at those plurality of different spatial positions that are located as close as possible to, or overlapping, a registered or estimated position of an ear of user when seated in the vehicle seat, as viewed in a vehicle lateral direction. Thereby, the actual microphone data registration step is performed beforehand, over a large measurement area that is deemed to correspond to a large part of the different kind of users that are expected to use the vehicle, and the raw microphone data is stored in the vehicle or in a cloud application. In a subsequent step, in response to initiation of a calibration process, the vehicle control system uses only the raw microphone data from relevant spatial positions, i.e. spatial positions located close to ear of current or planned next user, for audio system calibration. In other words, there is no need for renewed registration of microphone data during each calibration process.

In some example embodiments, that may be combined with any one or more of the above-described embodiments, the method comprises an initial step of controlling the at least one powered seat position actuator, by the control system, for moving the at least one microphone of the vehicle seat to a plurality of different spatial positions covering a major portion of all conceivable seat positions, and registering, at each of said different spatial positions, microphone data received from the at least one microphone while generating a calibration sound by means of a loudspeaker of the vehicle audio system; performing multiple calibrations for determining pre-determined calibration data for each of the plurality of different spatial positions covering the major portion of all conceivable seat positions; and upon obtaining instructions or determining need for performing a calibrating of the vehicle audio system, applying said pre-determined calibration data associated with the spatial positions that is located as close as possible to, or overlapping, a registered or estimated position of an ear of user when seated in the vehicle seat, as viewed in a vehicle lateral direction. Thereby, both the actual microphone data registration step and the microphone data analysis step are performed beforehand, over a large measurement area that is deemed to correspond to a large part of the different kind of users that are expected to use the vehicle, and optimal calibration setting for each spatial position of the ear of the user is determined beforehand. In a subsequent step, in response to initiation of a calibration process, the vehicle control system merely checks or estimates the position of the ear of the user and starts using the predetermined calibration profile previously stored and associated with the relevant position. In other words, there is no need for renewed registration of microphone data or microphone data analysis in order to apply another calibration for a new occupant ear position.

In some example embodiments, that may be combined with any one or more of the above-described embodiments, the method further comprising storing a vehicle audio calibrating setting resulting from a calibration process, and linking the stored vehicle audio calibrating setting with the current seat position, or seat memory preset, or a user identity; and applying said stored vehicle audio calibrating setting when the seat is moved to a position that has an audio setting linked thereto, or when a memory preset is selected that has an audio setting linked thereto, or when a user having a user identify linked to an audio calibration setting is entering the seat. As a result, substantially optimal sound for a specific seat memory preset is accomplished, thereby providing a fast and efficient adjustment of the audio system, without requiring a new calibration process for the specific seat memory preset.

In some example embodiments, that may be combined with any one or more of the above-described embodiments, the at least one microphones that is integrated in the seat headrest or upper region of the backrest is used also for other purposes, such as for example registering background noise for providing active road noise cancellation via the loudspeakers, registering voice commands via speech recognition enabling voice communication to other party within or outside of vehicle, voice recognition for biometrics, karaoke, or any other type communication and information entry use-cases. In other words, the microphones may have dual functionality.

In some example embodiments, that may be combined with any one or more of the above-described embodiments, the disclosure also relates to a vehicle, such as a car, comprising the vehicle audio system as described above.

To conclude, the seat can have left side microphone and a right side microphones, and the seat can be moved such that the two microphones move around the space where occupant ears are likely to be located. The microphone spacing in the lateral direction may be selected to correspond to the human ear spacing, such as for example in the range of 15-20 cm between left and right microphones. The movement of the seat can effectively replicate almost any number of relevant microphone positions in the X-Z plane and provides a good left-right data on the Y-axis.

The microphone data can be used as input for automatic speaker calibration algorithm that can individually calibrate the exact speaker elements in the vehicle for the desired seating position.

One example embodiment of a calibration process includes:
a user can initialize and calibration process, for example manually, wherein for example the current seat position, or other type of data, is used for estimating ear position of the user,
the vehicle control system may ask the user/driver to leave the vehicle and subsequently start-up the calibration process, or the vehicle control system may initiate the calibration process next time the vehicle is locked from the outside,
the control system would control the seat motion, such that the seat microphones are moved to predetermined array positions, and such that calibration signals are played via the loudspeaker while microphone data is registered as input data for the calibration process,
the microphone measurement data can then be processed either onboard the vehicle or sent to an online server for processing,
the new individual calibration profile is then applied to the sound system.
optionally, new individual calibration profile may be linked to the current seat memory preset, such that correct audio calibration is always provided in response to activation of a certain seat memory preset.

An alternative example embodiment of a calibration process involves:
the vehicle control system runs a measurement sequence covering substantially the complete interior environment in a single operation, for example before delivery of the vehicle to the customer, or in response to a user-initiated calibration. This will generally take much more time than merely measuring some spatial positions located in the head area of the user.

Upon subsequent calibration step, the control system may directly load, from the existing complete measurement data, only the relevant microphone data, i.e. the microphone data associated with the ear area, and process this loaded data by the calibration algorithm for obtaining a proper calibration setting and good sound quality, all without requiring user to step out of the vehicle. This is of course much more convenient, but requires storage of lot of measurement data; running of a lot of measurements in advance, and user would not witness the measurement process in operation.

According to still a further alternative example embodiment of a calibration process:
the vehicle control system runs a measurement sequence covering substantially the complete interior environment in a single operation, for example before delivery of the vehicle to the customer, or in response to a user initiated calibration, as well as processing this registered microphone data by the calibration algorithm for obtaining a proper calibration setting for each spatial position, and storing said predetermined calibration data in a memory of the vehicle, or remotely on a server.

Upon subsequent initialization of an audio calibration process, the control system may directly load, from the existing optimal calibration setting for each spatial position, the relevant predetermined calibration setting, for obtaining a proper calibration setting and good sound quality, all without requiring user to step out of the vehicle. This requires even more processing at the initial step, but may be even more convenient to the user, because it is faster and requires less storage space. This allows near instant switching of calibrations, less storage compared to storing raw measurements, at the expense of additional calculations needed to pre-calculate calibrations for unused seating positions.

Further features and advantages of the invention will become apparent when studying the appended claims and the following description. The skilled person in the art realizes that different features of the present disclosure may be combined to create embodiments other than those explicitly described hereinabove and below, without departing from the scope of the present disclosure.

### BRIEF DESCRIPTION OF THE DRAWINGS

The method and system for calibrating a vehicle audio system of a vehicle according to the disclosure will be described in detail in the following, with reference to the attached drawings, in which

FIG. 1 shows schematically a side-view of an example vehicle that may be implemented with the audio system and method according to the disclosure,

FIG. 2A shows a schematic layout of an example embodiment of the vehicle system according to the disclosure,

FIG. 2B-2C show example seats that may have microphones integrated therein,

FIG. 3 shows a schematic layout of a further example embodiment of the vehicle system according to the disclosure,

FIG. 4A-4E show various example embodiments of the method according to the disclosure,

FIG. 5 shows an example of a motion series of the vehicle seat,

FIG. 6 shows a further example of a motion series of the vehicle seat,

FIG. 7 shows an example embodiment of a seat having powered seat position actuators,

FIG. 8A shows a schematic layout of yet a further example embodiment of the vehicle system according to the disclosure,

FIG. 8B shows a schematic layout of still a further example embodiment of the vehicle system according to the disclosure,

FIG. 9 shows an example embodiment of a measurement area having five spatial positions,

FIG. 10 shows an example of a vehicle seat setting with a relatively long user, and

FIG. 11 shows an example of a vehicle seat setting with a relatively short user.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments but are applicable on other variations of the disclosure.

Those skilled in the art will appreciate that some of the steps and functions explained herein may be implemented using individual hardware circuitry, using software functioning in conjunction with a programmed microprocessor or general purpose computer or using one or more Application Specific Integrated Circuits (ASICs) and/or using one or more Digital Signal Processors (DSPs). It will also be appreciated that when the present disclosure is described in terms of a method, some of the steps may also be embodied in one or more processors and one or more memories coupled to the one or more processors, wherein the one or more memories store one or more programs that perform the steps, services and functions disclosed herein when executed by the one or more processors.

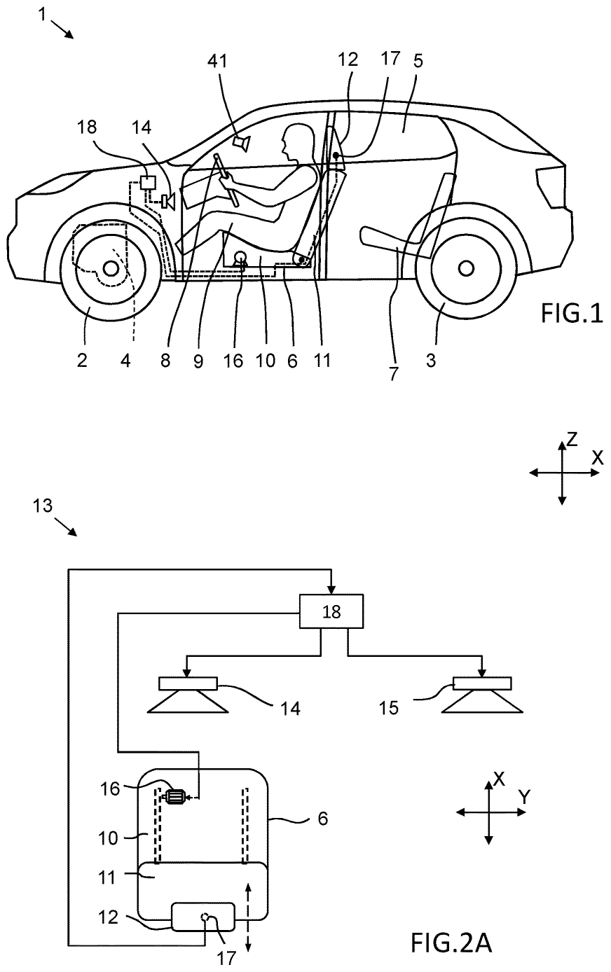

For setting the method for calibrating a vehicle audio system of a vehicle, and associated system, of the disclosure in an example context, FIG. 1 shows an example of a vehicle that may be equipped with an vehicle audio system according to the disclosure, and the method for calibrating a vehicle audio system according to the disclosure may for example be executed partly or completely in a vehicle according to FIG. 1.

Specifically, FIG. 1 schematically shows a vehicle 1 defining a longitudinal direction X, a vertical direction Z, and a lateral direction that is perpendicular to both the longitudinal direction X and the vertical direction Z.

The example vehicle 1 of FIG. 1 has front wheels 2, rear wheels 3, a propulsion source 4 and a passenger cabin 5 with front seats 6, rear seats 7 and a steering wheel 8. The vehicle according to the example embodiment of FIG. 1 may further include an image detector 41 within the passenger cabin 5 and configured for detecting user body posture, or at least user ear position. The user 9 is herein referred to the person occupying the driver seat of the vehicle 1.

If the vehicle 1 is a self-driving vehicle without a dedicated driver seat, the user may be seated in virtually any seat of the vehicle 1.

In the example vehicle of FIG. 1, the user 9 is sitting in the driver front seat 6, which may include a seat cushion 10, a backrest 11 and a headrest 12.

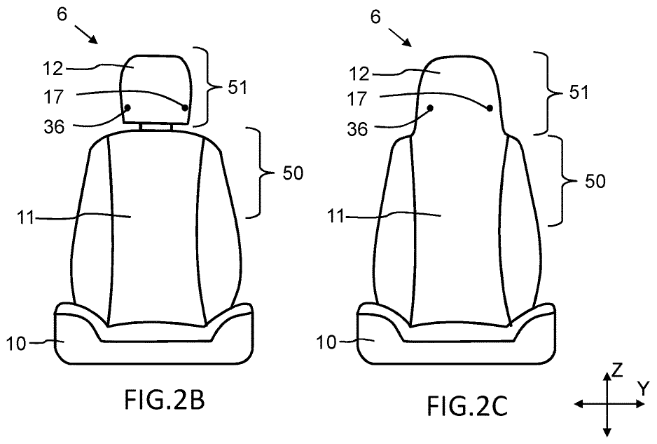

FIG. 2A shows an example schematic layout of the vehicle system 13 according to the disclosure implemented in a vehicle 1. With reference to FIG. 1 and FIG. 2A, the vehicle system 13 comprises a vehicle audio system having a set of loudspeakers 14, 15. The vehicle system 13 further comprises a power-adjustable, in particular electrically power-adjustable, vehicle seat 6 that includes a seat cushion 10, a seat backrest 11, an integrated or separate seat headrest 12, at least one microphone 17 integrated in the seat headrest 12 or upper region of the backrest 11, and at least one powered seat position actuator 16, specifically at least one electrically powered seat position actuator, for enabling adjustment of the vehicle seat position.

The seat 6 may for example be power-adjustable in the longitudinal direction X, as illustrated by dotted arrow in FIG. 2A. The seat 6 may of course alternatively, or in addition, be power-adjustable in the vertical direction Z, and/or the inclination of the seat backrest 11 may be power-adjustable, or the like.

The powered seat position actuator 16 may for example be a linear electric actuator having an electric motor operably connected to rolling or sliding linear bearing arrangement, that is configured to enable linear seat adjustment of the seat in the longitudinal direction X.

FIG. 2B shows an example of a front-view of a seat having a separate seat headrest 12, i.e. a headrest 12 that is mounted on, and often separable from, the backrest 11. FIG. 2C shows an example of a front-view of a seat having an integrated seat headrest 12, i.e. a headrest 12 that made in one piece with backrest 11. The upper area 51 of the seat in FIGS. 2b and 2C corresponds to the head rest 12.

The term “upper region of the backrest” herein refers to having the at least one microphone 17 integrated for example in the upper half portion 50 of the backrest 11, as indicated in FIGS. 2b and 2C, or integrated in the uppermost quarter portion of backrest 11, or uppermost sixth portion of backrest 11.

According to some example embodiments, the seat 6 may include two microphones, a first microphone 17 and a second microphone 36. These may preferably be positioned with ears distance between in each other, in the lateral direction Y.

The vehicle system 13 further comprises a control system 18 configured for controlling operation of the powered seat position actuator 16. The control system 18 is typically also configured for controlling operation the vehicle audio system.

The control system 18 is configured for controlling the at least one powered seat position actuator 16, by the control system 18, for moving the at least one microphone 17 of the vehicle seat 6 to a plurality of different spatial positions within the vehicle passenger cabin 5.

The motion of the at least one microphone 17 is accomplished by moving the seat 6 by means of the powered seat position actuator 16. In other words, the powered seat position actuator 16 is controlled, by the control system 18, for moving at least a portion of the seat, such that the at least one microphone 17 of the vehicle seat 6 moves to a plurality of different spatial positions within the vehicle passenger cabin 5.

The control system 18 is also configured for registering, at each of said different spatial positions, microphone data received from the at least one microphone 17 while generating a calibration sound by means of the loudspeaker 14, 15 of the vehicle audio system.

The calibration sound is preferably generated by a single loudspeaker, such as for example the first loudspeaker 14 or the second loudspeaker 15, or by the first and second loudspeakers consecutively, i.e. one after the other. However, in some example embodiments, the calibration sound may be generated by the first and second loudspeakers 14, 15 jointly, i.e. simultaneously.

Finally, the control system 18 is configured for calibrating the vehicle audio system based on the registered microphone data received from the at least one microphone 17.

By analysing the registered microphone data received from the at least one microphone 17 at each of said different spatial positions within the vehicle passenger cabin 5, the control system 18 can take all these microphone data into account, and calibrate the vehicle audio system such that the sound quality, as perceived by a vehicle user that is seated in the seat, is high.

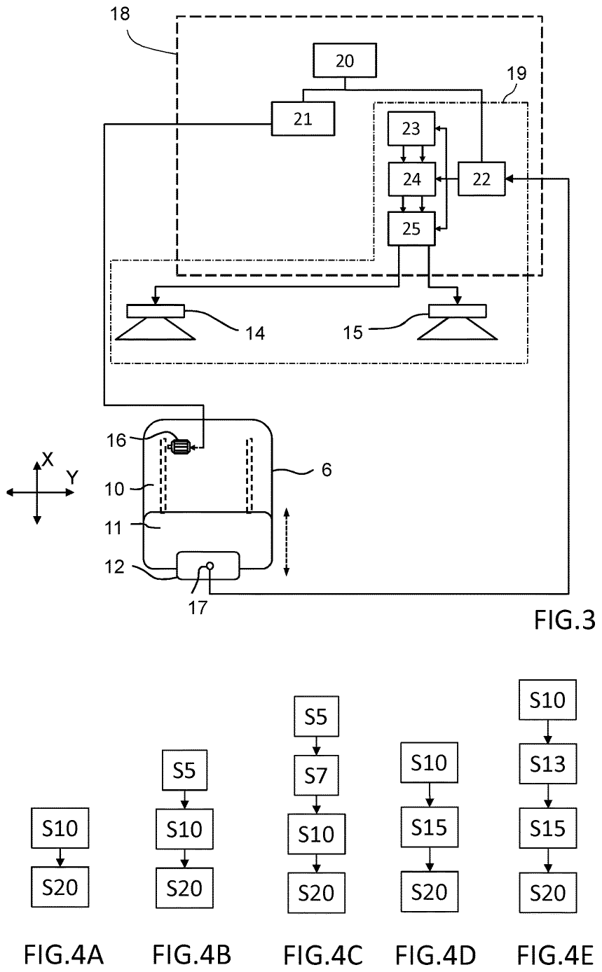

The control system 18 may be implemented in various ways, for example more or less distributed. In the example embodiment schematically illustrated in FIG. 3, the control system functionality is distributed across multiple individual control systems that are interconnected, for example via a common gateway arrangement 20.

Specifically, the control system 18 may include a seat control system 21, which may include a dedicated controller (ECU), for controlling operation of the seat position actuator 16.

In addition, the control system 18 may include a vehicle audio system 19, which may include a dedicated audio or multimedia controller (ECU) 22, for controlling operation of the parts of the vehicle audio system 19. The parts of the vehicle audio system 19 may for example be an audio source part 23, preferably a multichannel source, such as for example an audio streaming provider or digital audio files stored locally.

Another part of the vehicle audio system 19 may be a digital signal processing (DSP) part 23, which may include for example parametric equalizers, adjustable electronic crossovers and signal delay processors, etc.

Still another part of the vehicle audio system 19 may be a power amplifier part 25 that are connected with the loudspeakers 14, 15. In the example embodiment of FIG. 3, the power amplifier part 25 has two output channels, wherein the first loudspeaker 14 is connected a first output channel of the power amplifier part 25, and the second loudspeaker 15 is connected the a second output channel of the power amplifier part 25.

The parts 22-25 of vehicle audio system 19 may be partly or completely integrated as a single unit. Similarly, the seat control system 21 may be integrated with other parts of the vehicle system 13.

One example embodiment of the method for calibrating a vehicle audio system of a vehicle will be described below with reference to FIG. 4A, which schematically shows the basic steps of the method. As described above with reference to FIGS. 1 to 3, the vehicle 1 comprises an audio system 19 having a set of loudspeakers 14, 15, and a power-adjustable vehicle seat 6 including a seat cushion 10, a seat backrest 11, a seat headrest 12, at least one microphone 17 integrated in the seat headrest 12 or upper region of the backrest 11, and at least one powered seat position actuator 16 for enabling adjustment of the vehicle seat position. The vehicle 1 further comprises a control system 18 configured for controlling operation of the powered seat position actuator 16 and the audio system 19. The method comprises a first step S10 of controlling the at least one powered seat position actuator 16, by the control system 18, for moving the at least one microphone 17 of the vehicle seat 6 to a plurality of different spatial positions, and registering, at each of said different spatial positions, microphone data received from the at least one microphone 17 while generating a calibration sound by means of a loudspeaker 14, 15 of the vehicle audio system 19. The method further comprises a second step S20 of calibrating the vehicle audio system 19 based on the registered microphone data received from the at least one microphone 17.

The term plurality of different spatial positions refers herein to a plurality of different locations within a Z-X plane. Consequently, the seat 6 is moved to a plurality of different locations within the Z-X plane, such that the at least one microphone 17 of the vehicle seat 6 is moved to a plurality of different spatial positions. The movement of the seat 6 may be accomplished by means of motion of the entire seat in the longitudinal direction X, and/or by adjusting the inclination of the backrest and/or head rest, and/or by adjusting the position of the seat 5 in the vertical direction Z.

As an example, FIG. 5 shows a schematic illustration of how the seat is moved from an initial seat position 26 step-wise forwards in the longitudinal direction X of the vehicle 1 by means of a powered seat position actuator 16 to a first seat measurement position 27, and then further forwards in the longitudinal direction X to a second seat measurement position 28, and thereafter further forwards in the longitudinal direction X to a third seat measurement position 29. This seat motion sequence moves the microphone 17 from an initial microphone position 30, forwards to a first microphone measurement position 31, then further forwards to a second microphone measurement position 32, and thereafter further forwards to a third microphone measurement position 33.

The first step S10 of the method described above may thus for example involve controlling the powered seat position actuator 16 for moving the seat 6 from an initial seat position 26 to a first seat measurement position 27, such that the microphone 17 of the seat 6 is moved to from the initial microphone position 30 to the first microphone measurement position 31. At this first position, a loudspeaker 14, 15 generates a calibration sound that is registered by the microphone 17.

Thereafter, the powered seat position actuator 16 is controlled for moving the seat 6 from the first seat measurement position 27 to the second seat measurement position 28, such that the microphone 17 of the seat 6 is moved to from the first microphone measurement position 31 to the second microphone measurement position 32. At this second position, a loudspeaker 14, 15 generates a calibration sound that is registered by the microphone 17.

Finally, the powered seat position actuator 16 is controlled for moving the seat 6 from the second seat measurement position 28 to the third seat measurement position 29, such that the microphone 17 of the seat 6 is moved to from the second microphone measurement position 32 to the third microphone measurement position 33. At this third position, a loudspeaker 14, 15 generates a calibration sound that is registered by the microphone 17.

Thereby, microphone data received from the microphone 17 is collected from each of said different spatial positions, i.e. from each of the first to third microphone measurement positions 31-33.

In this example, the first to third microphone measurement positions 31-33 represent the different spatial positions of the microphone.

The first to third microphone measurement positions 31-33 are preferably selected such that the microphone during the calibration sound registration is located closer to the actual ear position of the user, when the user is located in the seat. Thereby, the calibration process will deliver more relevant microphone data and the calibration will provide improved result.

The illustrated example of FIG. 5 is merely one example embodiment of how the seat can be moved accomplish a plurality of different spatial positions of the microphone 17.

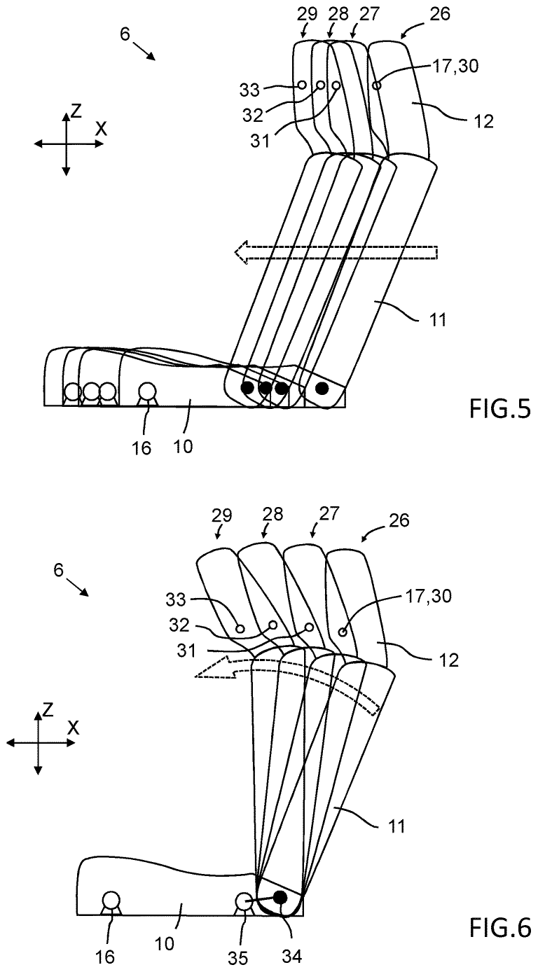

FIG. 6 schematically illustrates a further example embodiment of how the seat can be moved accomplish a plurality of different spatial positions of the microphone 17. Specifically, in this example, the seat 6 comprises a powered seat position actuator 35 that is configured to control the inclination level of the backrest 11. Consequently, step S10 of the above-described method, involves moving the seat backrest 11 from the initial seat position 26 step-wise forwards around a pivot point 34, as illustrated by a dotter arrow in FIG. 6, by means of the powered seat position actuator 35 to a first seat measurement position 27, and registering by the microphone 17 at this position a calibration sound that is generated by the loudspeaker 14, 15, and then moving the seat backrest 11 from the first seat measurement position 27 forwards around a pivot point 34 to a second seat measurement position 28, and registering by the microphone 17 at this position a calibration sound that is generated by the loudspeaker 14, 15, and then moving the seat backrest 11 from the second seat measurement position 28 forwards around a pivot point 34 to a third measurement position 29, and registering by the microphone 17 at this position a calibration sound that is generated by the loudspeaker 14, 15.

Clearly, more advanced or complex patterns of the plurality of different spatial positions of the microphone 17 can be accomplished by using two or more powered seat position actuators 16, 35. For example, modern vehicle seats 6 typically has individual powered seat position actuators for controlling longitudinal seat position, seat height position, seat cushion inclination level, seat backrest inclination level, and/or seat headrest inclination position, etc., for the purpose of enabling a comfortable seating position for each driver, irrespective of size and body posture. In other words, almost any type of pattern of spatial positions of the microphone 17 in the X-Z plane can be accomplished by means of the standard powered seat position actuators of the vehicle.

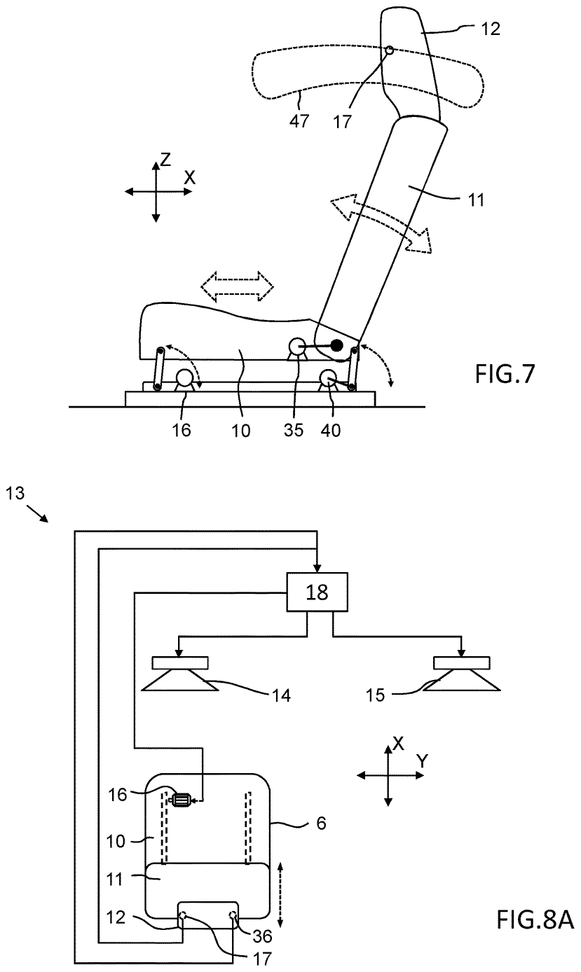

For example, FIG. 7 schematically shows an example embodiment of a vehicle seat 6 having an individual powered seat position actuator 16 for controlling longitudinal seat position, a further individual powered seat position actuator 35 for controlling inclination level of the seat backrest 11, and still a further individual powered seat position actuator 40 for controlling seat height position. Each of these individual powered seat position actuators 16, 35, 40 can be controlled to move independently, and they can be jointly controlled for moving the microphone 17 over total or maximal movement area 47 in the X-Z plane.

Since the standard, already available powered seat position actuators of the vehicle are used for moving the microphone 17 to the plurality of different spatial positions during the calibration phase, there is thus no need for any special or dedicated power actuators for moving the microphone 17.

The number of different spatial positions, at which microphone data received from the at least one microphone 17 is registered, can be freely selected. However, for avoiding a very long calibration process, while still being able to rely on microphone measurement data from a plurality of measurements, the number of different spatial positions used for registering microphone data may for example be in the range of 2-20, specifically 3-15, and more specifically 4-10.

Consequently, in some example embodiments of the method for calibrating a vehicle audio system of a vehicle, the first step S10 of controlling the at least one powered seat position actuator 16, 35 involves controlling the at least one powered seat position actuator 16, 35 for moving the at least one microphone 17 of the vehicle seat to a at least four, specifically in the range of 4 to 10, different spatial positions, wherein the step of registering microphone data involves registering, at each of said at least four different spatial positions, microphone data received from the at least one microphone while generating a calibration sound by means of a loudspeaker of the vehicle audio system, and wherein the second step S20 of calibrating the vehicle audio system involves calibrating the vehicle audio system based on the registered microphone data received from each of said at least four different spatial positions.

A further improvement in the audio system sound quality by means of the method for calibrating a vehicle audio system according to the present disclosure may be accomplished by providing the power-adjustable vehicle seat with two or more microphones, because this enables the registered microphone data to be captured at a location that is closer to the estimated positions of a user's ears, when seated in the seat 6. Moreover, providing the power-adjustable vehicle seat with two or more microphones also enables increased number microphone data registration locations without increased movement of the seat, thereby providing improved calibration result without any significant increase in calibration time.

For example, one microphones may be positioned on a left side region of the seat headrest or upper left side region of backrest, and another microphone may be positioned on a right side region of the headrest or upper right side region of backrest. This enables movement of the microphones to an area that is very close to the estimated positions of a user's ears, when seated in the seat 6.

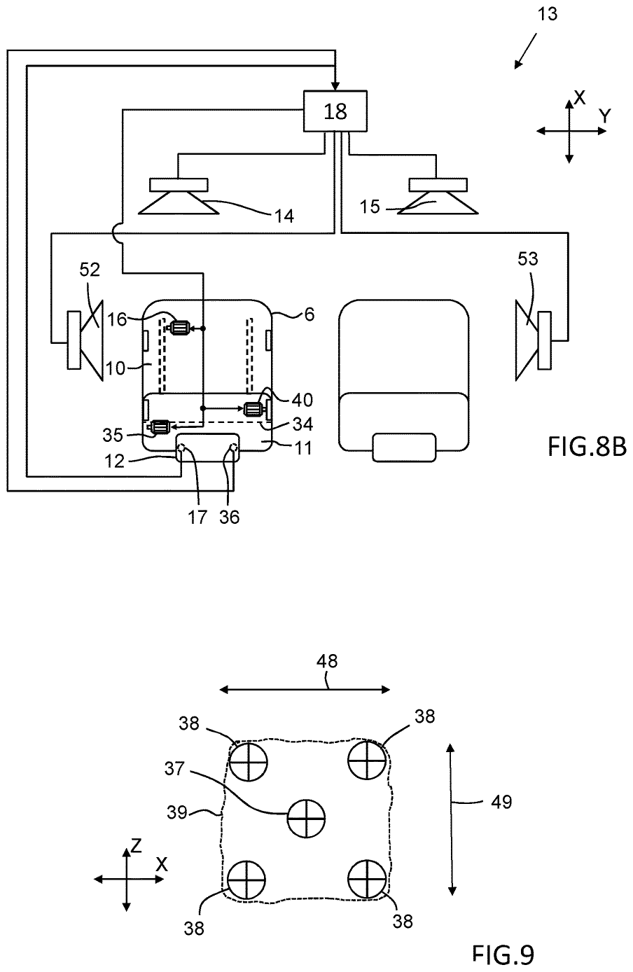

Specifically, FIG. 8A shows a seat and a vehicle audio system with a first microphone 17 positioned on a left side region of the seat headrest 12, and a second microphone 36 positioned on a right side region of the headrest 12.

Consequently, in some example embodiments of the method for calibrating a vehicle audio system of a vehicle, the power-adjustable vehicle seat includes at least two microphones, wherein a first microphone 17 of said at least two microphones is integrated in a left side region of the seat headrest or upper left side region of backrest, and wherein a second microphone 36 of said at least two microphones is integrated in a right side region of the headrest or upper right side region of backrest, wherein the first step S10 of controlling the at least one powered seat position actuator involves controlling the at least one powered seat position actuator for moving each of said first and second microphones of the vehicle seat to a plurality of different spatial positions, wherein the first step S10 of registering microphone data involves registering, at each of said different spatial positions, microphone data received from each of said first and second microphones while generating a calibration sound by means of a loudspeaker of the vehicle audio system, and wherein the second step S20 of calibrating the vehicle audio system involves calibrating the vehicle audio system based on the registered microphone data received from each of the first and second microphones.

In case the vehicle audio system includes at least two microphones, the first step S10 of controlling the at least one powered seat position actuator may involve controlling the at least one powered seat position actuator for moving each of said first and second microphones of the vehicle seat to a at least four different spatial positions, and wherein registering microphone data involves registering, at each of said at least four different spatial positions, microphone data received from each of said first and second microphones while generating a calibration sound by means of a loudspeaker of the vehicle audio system.

Virtually all vehicle audio systems includes a plurality of loudspeakers, such as two, three, four, five, six or more loudspeakers. The power amplifier of such an audio system typically includes a plurality of output channels for enabling reproduction of multichannel sound from a multichannel music source. Calibration of an audio system having a plurality of loudspeakers, of which at least some are connected to different channels, may benefit from calibration of each channel individually. Thereby, the individual characteristics of the audio components of each channel may be taking into account for providing an overall better calibrations and sound quality.

In other words, in case the audio system includes a power amplifier having at least a first output channel and a second output channel, and a first loudspeaker connected to the first output channel and a second loudspeaker connected to the second output channel, the first step S10 of registering microphone data may involve registering, at each of said different spatial positions, microphone data received from the at least one microphone while generating a calibration sound by means of the first loudspeaker individually or separately, and while generating a calibration sound by means of the second loudspeaker individually or separately.

Similarly, in case the audio system includes a vehicle seat with at least two microphones, at least two loudspeakers, and wherein the calibration involves microphone registrations of at least four positions,

Similarly, in case the audio system includes a power amplifier having at least a first output channel and a second output channel, and a first loudspeaker connected to the first output channel and a second loudspeaker connected to the second output channel, and the calibration involves microphone registrations at least four positions, the first step S10 of controlling the at least one powered seat position actuator involves controlling the at least one powered seat position actuator for moving each of said first and second microphones of the vehicle seat to a at least four different spatial positions, and registering, at each of said at least four different spatial positions, microphone data received from each of said first and second microphones while generating a calibration sound by means of the first loudspeaker individually or separately and while generating a calibration sound by means of the second loudspeaker individually or separately.

Furthermore, as mentioned above, the seat generally involves a plurality of powered seat position actuators that may be used for controlling the position of the microphones during the microphone recordings of the calibrations process. Consequently, in case the electrically power-adjustable vehicle seat includes at least two powered seat position actuators, of which a first powered seat position actuator is configured for enabling adjustment of a longitudinal and/or vertical position of the seat cushion of the vehicle seat, and a second powered seat position actuator is configured for enabling adjustment of an angular position of the seat backrest of the vehicle seat, the first step S10 of controlling the at least one powered seat position actuator involves controlling the at least first and second powered seat position actuators for moving each of said first and second microphones of the vehicle seat to a at least four different spatial positions, and registering, at each of said at least four different spatial positions, microphone data received from each of said first and second microphones while generating a calibration sound by means of the first loudspeaker individually or separately and while generating a calibration sound by means of the second loudspeaker individually or separately.

Specifically, FIG. 8B shows a vehicle system comprising: a vehicle audio system having four loudspeakers 14, 15, 52, 53 and four output channels, each connected to an individual loudspeaker 14, 15, 52, 53; a power-adjustable vehicle seat including a first microphone integrated in the left side of the seat headrest 12 and a second microphone integrated in the right side of the seat headrest 12, and a first powered seat position actuator 16, 35, 40 for enabling adjustment of the vehicle seat in the longitudinal position X, a second powered seat position actuator 35 for enabling adjustment of the inclination of the back rest 11 of the vehicle seat around a pivot point 34, and a third powered seat position actuator 40 for enabling adjustment of the vehicle seat height in the vertical direction Z; and a control system 18 configured for controlling operation of the first to third powered seat position actuators 16, 35, 40. The control system 18 is configured for: controlling the first, second and third powered seat position actuators 16, 35, 40, by the control system 18, for moving each of the first and second microphones of the vehicle seat to a plurality of different spatial positions, and registering, at each of said different spatial positions, microphone data received from each of said first and second microphones while generating a calibration sound by means of each of the first to fourth loudspeakers 14, 15, 52, 53 of the vehicle audio system individually and sequentially at each of said spatial positions; and calibrating the vehicle audio system based on the registered microphone data received from the first and second microphones at each of said spatial positions.

As mentioned above, by registering a generated calibration sound at a plurality of different spatial positions that are located in focused region matching or located adjacent an estimated or detected ear position of a user when seated in the vehicle, the overall calibration result may be improved by relying on microphone measurement data from the plurality of measurements. This may be useful for avoiding that a single calibration measurement is performed at a position that exhibits relatively strong sound interference of some kind, and thus may result in a poor calibration result.

The geographical distribution of the plurality of different spatial positions in the X-Z plane, and the number of the plurality of different spatial positions, may be varied to a large extent.

FIG. 9 shows an example embodiment of the calibration method having a five planned measurement positions comprising one centre measurement position 37 and four individual outer measurement positions 38 that are distributed and surrounding the centre position 37.

The different spatial positions, at which microphone data received from the at least one microphone 17 are registered, define a measurement area 39, as schematically illustrated in FIG. 9. The measurement area 39 area may be defined by the outermost lines interconnecting the various spatial positions 37, 38.

In some example embodiments, the microphone measurement data from each measurement position may be assigned equal weight, i.e. calibration is performed while taking the microphone measurement data from each position, of the different spatial positions, equally into account. However, in some example embodiments, the microphone measurement data from each measurement position may be assigned different weight.

In the example embodiment of FIG. 9, the measurement data received from the centre measurement position 37 may be deemed more relevant for the calibration process than the measurement data received from the four individual outer measurement positions 38. However, as discussed above, the measurement data received from the four individual outer measurement positions 38 are nevertheless taken into account in case the centre measurement position 37 happens to deliver poor measurement results due to a local interference effect.

One example solution may for example involve to assign 50% weight to the measurement data received from the centre measurement position 37, and assign each measurement data received from the four individual outer measurement positions 38 with 12.5% weight.

Consequently, in some example embodiments, the second step S20 of calibrating the vehicle audio system involves calibrating the vehicle audio system based on the registered microphone data received from each of said plurality of different spatial positions, wherein a relevance of said registered microphone data received from each of said plurality of different spatial positions are weighted differently when calibrating the vehicle audio system based on said registered microphone data.

In other words, the relevance of registered microphone data received from at least one of said plurality of different spatial positions is weighted stronger than the relevance of registered microphone data received from at least another of said plurality of different spatial positions differently when calibrating the vehicle audio system based on said registered microphone data.

The term “weighted” refers herein to the level of significance of a registered microphone data, i.e. how much the microphone data of a specific location influences the final calibration result, compared with the microphone data of other locations.

One approach for determining the level of weight of microphone data registered at a certain location, may be to make the weight a function of a distance between said certain location and a registered or estimated position of an ear of user when seated in the vehicle seat, as seen in the X-Z plane.

In other words, the level of weight of microphone data registered at a first location may be deemed being larger than weight of microphone data registered at a second location, in case the first location is located closer to a registered or estimated position of an ear of user when seated in the vehicle seat than the second location, as seen in the X-Z plane.

Consequently, the relevance of said registered microphone data received from each of said plurality of different spatial positions is weighted as a function of closeness of each of said plurality of different spatial positions, to a registered or estimated position of an ear of user when seated in the vehicle seat.

The function of closeness may reflect a stepwise or gradual decrease in relevance with decreased closeness of each of said plurality of different spatial positions.

The level of closeness of a certain measurement position 37, 38 is generally determined by measuring or calculating the distance between the measurement position 37, 38 and the registered or estimated position of an ear of user when seated in the vehicle seat, in the X-Z plane.

The measurement area 39 defined by a set of measurement positions 37, 38 having different spatial positions in the X-Z plane is generally relatively small and focused compared with a total or maximal movement area 47 of the at least one microphone of the seat in the X-Z plane, because the method for calibrating a vehicle audio system of a vehicle according to the present disclosure is configured for obtaining microphone measurement data only at relevant positions for the current user.

In other words, during a calibration process, the method does not obtain microphone measurement data at fixed predetermined positions covering a relatively large predetermined area in the X-Z plane that reflects a normal area of a head of most of the vehicle users, but instead at adaptable measurement positions 37, 38 covering a variable and relatively small measurement area 39 in the X-Z plane, wherein the measurement positions 37, 38 during each calibration process are determined based on at least one parameter reflecting the current or more recent user, in particular reflecting an ear position of the current or more recent user when seated in the seat 6. Each calibration process is thus dedicated and adapted to fit the current or more recent user.

For example, the size of the measurement area 39 defined by a set of measurement positions 37, 38 in FIG. 9 may have a length 48 in the longitudinal direction X of the vehicle in the range of 0-20 cm, specifically 0-10 cm, and a height 49 in the vertical direction Z of the vehicle in the range of 0-20 cm, specifically 0-10 cm. The length or height “0 cm” refers herein simply to single straight line of measurement positions in the vertical or horizontal direction, respectively.

The method and system according to the present disclosure may rely on many different types of parameters for reflecting an ear position of the current or more recent user when seated in the seat 6. For example, the control system may be configured to use the position setting of the vehicle seat and/or position setting of the steering wheel as input parameter for determining the measurement positions 37, 38.

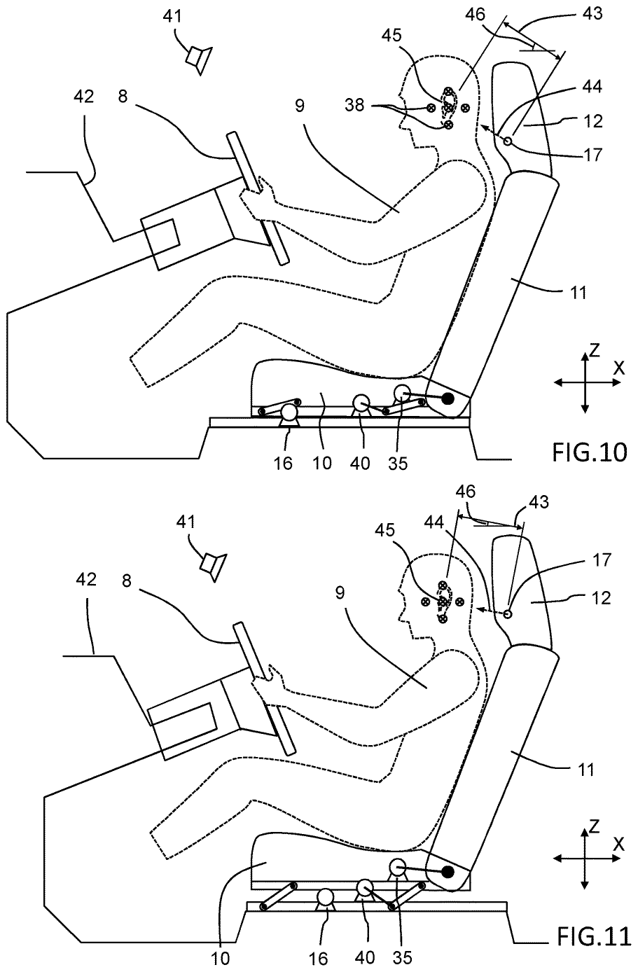

FIGS. 10 and 11 schematically shows how the position setting of the vehicle seat and/or position setting of the steering wheel can be used as input parameter for determining the measurement positions 37, 38, wherein FIG. 10 schematically shows the position of the vehicle seat 6 and position of the steering wheel 8 after adjustment by a relatively tall driver or user 9, and FIG. 11 schematically shows the position of the vehicle seat 6 and position of the steering wheel 8 after adjustment by a relatively short driver or user 9.

Specifically, in the example illustration of FIG. 10, the relatively tall driver or user 9 has adjusted the seat height to a relatively low seating position for avoiding getting too close to the vehicle interior roof. The relatively tall driver or user 9 has also adjusted the seat longitudinal position along the X-axis to a position towards the rear of the vehicle, i.e. away from the steering wheel 8, for providing a comfortable leg position to the vehicle brake and acceleration pedals. Finally, the relatively tall driver or user 9 has also adjusted the steering wheel position along a steering column direction a position towards the rear of the vehicle, i.e. away from a vehicle dashboard 42, for providing a comfortable arm position when holding the steering wheel 8.

Moreover, in the example illustration of FIG. 11, the relatively short driver or user 9 has adjusted the seat height to a relatively high seating position for ensuring good view in the traffic situation over the steering wheel 8. The relatively short driver or user 9 has also adjusted the seat longitudinal position along the X-axis to a position towards the front of the vehicle, i.e. towards the steering wheel 8, for providing a comfortable leg position to the vehicle brake and acceleration pedals. Finally, the relatively short driver or user 9 has also adjusted the steering wheel position along a steering column direction a position towards the front of the vehicle, i.e. towards the vehicle dashboard 42, for providing a comfortable arm position when holding the steering wheel 8.

Consequently, as schematically illustrated on FIGS. 10 and 11, it possible to make an estimation of the ear position 45 of the user based on the current vehicle seat setting and/or vehicle steering wheel setting and based on an average body size and/or shape, and/or body posture, of all relevant human users.

In other words, it is possible, based on an average body size and/or body shape and/or body posture of all relevant human users, to prepare a lockup table having one or more input parameters, such as vehicle seat setting and/or vehicle steering wheel setting, and having position settings of one or more powered seat position actuators as output parameters, wherein the outputted position settings of one or more powered seat position actuators as output parameters results in positioning of the microphone 17 in the area of the ear of the user, before motion of the seat 6.

For example, in the schematic illustration of FIG. 10, the microphone 17 needs to be moved a predetermined length 43 forwards and upwards along a straight motion path, as depicted by arrow 44, having an angle 46 of about 40 degrees to the horizontal plane.

Similarly, in the schematic illustration of FIG. 11, the microphone 17 needs to be moved a predetermined length 43 forwards and upwards along a straight motion path, as depicted by arrow 44, having an angle 46 of about 10 degrees to the horizontal plane.

As a result, the control system 18 may configured to use a predetermined lockup table for determining how the relevant one or more powered seat position actuators 16, 35, 40 should be controlled for moving the microphone 17 to the estimated ear position 45 of the user, as a function of one or more input parameters, such as vehicle seat setting and/or vehicle steering wheel setting.

The automatic motion of the seat 6 by the control system 18 for moving the moving the microphone 17 to the estimated ear position 45 of the user is intended to be performed when the seat is empty, and this may be verified by the control system 18 by some type of well-known user presence detection, such as seating weight detection, etc.

The vehicle control system 18 may obtain other type of input data reflecting the size, shape and/or body posture of the current or more recent user. For example, the control system 18 may obtain input data reflecting a user's size, shape and/or body posture from a vehicle interior camera 41 or other type of image detector. A vehicle interior camera 41 or other type of image detector may alternatively be used for directly detecting and registering the ear position of a user when seated in the seat.

This may for example be implemented by processing received camera image data by a head and/or ear detection and position tracking algorithm. Such detection and position tracking algorithms are quite common nowadays in “driver monitoring” systems in vehicles that may be used for various purposes, such as detecting and monitoring driver tiredness, detecting and monitoring acceptable seating position for airbag deployment, detecting and monitoring driver road and traffic attention, or the like. Moreover, there are also other user head-tracking technologies available as well, using for example in-vehicle radar, lidar, structured light, stereo imaging, ultrasound, etc.

The vehicle control system 18 may of course also be configured to move the microphone 17 to a predetermined layout of the plurality of different spatial positions centred around the estimated or registered ear position of the user.

To conclude, the control of the at least one powered seat position actuator 16, 35, 40, for moving the at least one microphone 17 of the vehicle seat 6 to a plurality of different spatial positions, is based on at least one of the following parameters: position setting of the vehicle seat, position setting of the steering wheel, registered or estimated body length of a current or most recent user of the seat, registered or estimated ear position of current or most recent user of the seat, when seated in the vehicle seat.

Furthermore, the at least one powered seat position actuator 16, 35, 40 is controlled, such that a centre of said plurality of different spatial positions, at which microphone data received from the at least one microphone 17 is registered, is located substantially as close as possible to, or overlapping, or at least adjacent to, a registered or estimated position of an ear of user when seated in the vehicle seat 6, as viewed in a vehicle lateral direction Y. The term adjacent refers herein to a distance of not more than 15 cm, specifically not more than 10 cm, and more specifically not more than 5 cm.

With reference again to FIG. 9, the different spatial positions 37, 38, at which microphone data received from the at least one microphone are registered, define a measurement area 39 that is smaller than 50%, specifically smaller than 25%, more specifically smaller than 10%, of a maximal area 47 reachable by said at least one microphone by control of the at least one powered seat position actuator, as viewed in a vehicle lateral direction. As mentioned above, the measurement area 39 may for example be defined by the outermost lines, of the set of lines defined by interconnecting all spatial positions.

The calibration process may for example be initialised automatically or by a service provider, or by the OEM, at regular or irregular intervals, or triggered automatically upon automatic detection of poor sound quality. According to another example embodiment, calibration process may be initialised by the user of the vehicle, for example when a new user wants to use the vehicle, and when a user deems that a calibration process is required. According to another example embodiment, calibration process may be initialised by vehicle service personnel as a service diagnostic procedure to diagnose audio system defect, such as for example for identifying audio system component failure for enabling quick and cost-efficient component replacement.

Consequently, with reference to FIG. 4B, the method may in some example embodiments further comprise an initial step S5 of obtaining instructions or determining need for performing a calibrating of the vehicle audio system, and in response thereto, going further to said first steps S10 of controlling the at least one powered seat position actuator 16 for moving the at least one microphone of the vehicle seat to a plurality of different spatial positions and registering, at each of said different spatial positions, microphone data while generating a calibration sound by means of a loudspeaker.

Sometimes, the calibration process may occur during a low interior cabin temperature, for example during winter conditions. However, the vehicle loudspeakers may exhibit reduced or modified frequency response and/or a different music reproduction behaviour when being in a cold state. Consequently, a calibration of the vehicle audio system in a cold temperature environment may provide poor sound quality when the vehicle driver compartment has been heated up to normal operating temperature. Consequently, the method may comprise an intermediate step S7 involving a warm-up sequence and/or a temperature equalization sequence of the one or more loudspeakers of the audio system that will be generating a calibration sound during registration of microphone data at each of said different spatial positions.

By performing a loudspeaker warm-up sequence, the operating temperature of the loudspeaker is increased, such that the sound quality of the vehicle audio system as perceived by the user is improved as a result of a subsequent calibration process.

A loudspeaker warm-up sequence may involve playing noise-like or ultra sound generating signal that causes heat-up of the loudspeaker as a by-product of the produced sound.

According to one example embodiment, the vehicle may include a temperature sensor for detecting the cabin interior temperature, and for inputting this information to the vehicle control system 18. In response to low interior cabin temperature, the control system 18 may perform a warm-up sequence of the loudspeakers for increasing the temperature of the loudspeaker, such that a calibration process delivers a better result in terms of sound quality in a warm vehicle.

According to most example embodiments, the control system 18 is configured to perform the calibration process of the vehicle audio system, including the motion of the at least one microphone 17 of the vehicle seat to a plurality of different spatial positions, and the registration of microphone data received from the at least one microphone, automatically. In other words, the control system 18 is configured to perform the entire calibration process by itself, without need for human interference or interaction.

For example, the method may comprises controlling the at least one powered seat position actuator, by the control system, for returning the seat to the position the seat had prior to start of the calibration process.

Hence, in response to a calibration process initialisation, the seat may first be moved to sound registration location, and after completed calibration sound registration, the seat is moved back to the original position, all by itself, controlled by control system via powered seat position actuator 16, 35, 40.

The calibration process is preferable performed while the vehicle is empty of users, because the users may otherwise interfere with the calibration sound registration, and the calibration test signals are usually not pleasant to listen to. Moreover, the motion of the vehicle seat 6 for moving the microphone to the estimated ear position of the user may be surprising and uncomfortable for the user if still seated in the seat 6.

Consequently, the control system is configured to perform the calibration process of the vehicle audio system, including the motion of the at least one microphone 17 of the vehicle seat to a plurality of different spatial positions and registering of microphone data received from the at least one microphone, when the vehicle is empty of users and the vehicle doors and windows are closed. Closed doors and window ensure low level of external interference sound.

The calibration process may for example be performed during vehicle still stand, or vehicle parking state, for avoiding measurement errors caused by human interaction and for reducing external sounds.

Furthermore, the control system may be configured to, prior to initialising said steps of moving the at least one microphone of the vehicle seat to a plurality of different spatial positions and registering, at each of said different spatial positions, microphone data while generating a calibration sound by means of a loudspeaker, requesting the user to leave the vehicle. The control system may for example request the user to leave the vehicle via an audio message, a written message at a display, or another information channel.

The actual calibration process, i.e. the microphone data processing for determining proper tuning or adjustment setting of the sound profile of each channel, may be performed by a processing unit in the vehicle, or by an external processing unit that has received the microphone data wirelessly from the control system 18 or audio system 19.

In other words, the second step S20 of calibrating a vehicle audio system based on the registered microphone data received from the at least one microphone may in some example embodiment involving: analysing the received microphone data received from the at least one microphone; and determining and applying a tuning profile to the signal of at least one output channel of the vehicle audio system.

The step of analysing and determining a tuning profile may be performed internally in a vehicle computer or via a remote server. The analysing and determining a tuning profile may for example be performed by running an analysing software; or by checking a look-up table.

The applying of a tuning profile, to the signal of at least one output channel of the vehicle audio system, for modifying the signal of at least one output channel, may for example involve applying a correction frequency profile, or applying a set of tuning parameters, such as for example gain, delay, phase equalization, array processing, etc., to the output signal of the vehicle audio system.

Calibration of the sound system may be performed to provide optimal sound quality for the user located in the seat 6. Alternatively, a plurality of seats 6 of the vehicle may be provided with at least one integrated microphone, and microphone data may be registered from a plurality of seats 6, and the second step S20 of calibrating a vehicle audio system based on the registered microphone data received from microphones from several seats may be performed to provide optimal sound quality for the group of user located in said plurality of seats 6, i.e. by optimizing the sound to be equally good at all seat locations having a microphone rather that optimizing towards a single seat.

The one, two or more microphones 17, 36 are preferably integrated or embedded in the seat 6, specifically in. The microphones may be compact microphones integrated in the seat headrest or upper region of the backrest, such as for example Micro-electromechanical system (MEMS) microphones, which are generally relatively low-cost, reliable and sufficient accuracy. The one, two or more microphones 17, 36 are thus typically mounted in the seat 6 already during manufacturing the vehicle, and the one, two or more microphones 17, 36 are configured to remain in the seat 6 during the lifetime of the vehicle.

The integration or embedding of the one, two or more microphones 17, 36 in the seat may cause distortion and/or damping of the registered calibration sound. However, by registering calibration sound by a microphone both outside of the seat and located at the integrated position within the seat, and analysing the difference in terms of registered sound and/or frequency profile, it is possible to determine a correction profile that may be applied to the registered calibration sound, for compensating for any distortion and/or damping effect caused by the integrated position of the microphones 17, 36.

Consequently, in some example embodiments, the step of analysing the received microphone data received from the at least one microphone involves applying a correction for eliminating or at least reducing the acoustical effects caused by having the at least one microphone embedded into the seat 6.

The type, character, frequency, strength, etc. of the generated calibration sound by means of a loudspeaker of the vehicle audio system may be of many different kinds, depending on the circumstances, the type of vehicle and the type of loudspeakers, etc.

For example, in some example embodiments, the generated calibration sound by means of a loudspeaker of the vehicle audio system is a white noise signal or a stepwise or gradually varying tonal signal. Other types of generated calibration sounds are possible.

In some example embodiments described above with reference to for example FIG. 7 or FIG. 9, the advantage of registering a generated calibration sound merely at a plurality of different spatial positions that are located in focused region matching or located adjacent an estimated or detected ear position of a user enables a quicker calibration process while still providing a high quality sound of the audio system for the user, as long as the user does not significantly change seating position and/or seat settings. Moreover, this type of calibration process, which actually registers new calibration sound during each calibration process, also takes long-term aging of the loudspeakers and amplifiers into account, etc. However, the calibration method according to the present disclosure may also be performed according to an alternative process, that may be preferred in some implementations.

According to this alternative calibration method, the control system is configured to perform an initial large calibration process in connection with manufacturing of the vehicle, and then to rely on the microphone data registered during this large calibration process during subsequent user or system initiated calibration events.

In other words, the control system may be configured to, in connection with manufacturing or delivery of the vehicle, to control the at least one powered seat position actuator for moving the at least one microphone of the vehicle seat to a plurality of different spatial positions distributed over substantially all realistically conceivable ear positions of the all possible future users, and registering, at each of said different spatial positions, raw microphone data received from the at least one microphone while generating a calibration sound by means of a loudspeaker of the vehicle audio system. The raw microphone data is stored either locally in the vehicle or in an external cloud data storage, and is accessible by the control system in response to initialisation of a vehicle audio system calibration event.

Specifically, the control system would then simply download the relevant stored raw microphone data, i.e. the microphone data that corresponds to the spatial positions associated with the ear position of the current or most recent vehicle user, and use this data for calibrating the audio system, as described with reference to the second step S20 in FIG. 4A.

Such a calibration process could thus be performed very quickly, because no new microphone data measurement is required, and the user does not even have to leave the vehicle.

The basic steps of this alternative calibration method is described below with reference to FIG. 4D, which includes an initial step S10 of controlling the at least one powered seat position actuator 16, 35, 40, by the control system 18, for moving the at least one microphone 17, 36 of the vehicle seat 6 to a plurality of different spatial positions 37, 38 covering a major portion, such as for example at least 50%, or at least 75%, of all conceivable seat positions, and registering, at each of said different spatial positions 37, 38, microphone data received from the at least one microphone 17, 36 while generating a calibration sound by means of a loudspeaker 14, 15 of the vehicle audio system. The initial step S10 also includes storing the microphone data locally or in a cloud storage. The method further includes a subsequent step S15 of obtaining instructions or determining need for performing a calibrating of the vehicle audio system. Thereafter, the method includes a third step S20 of performing the calibrating of the vehicle audio system based on the stored raw microphone data registered at those plurality of different spatial positions that are located as close as possible to, or overlapping, a registered or estimated position of an ear of user when seated in the vehicle seat, as viewed in a vehicle lateral direction.

In the method according to FIG. 4D, the initial step S10 is typically performed at least in connection with manufacturing or delivering the vehicle, and subsequent steps S15 and S20 are generally performed after deliver to a user. The initial step S10 may however be repeated sometimes after delivery to the user for updating the stored raw measurement data, for example once every year or the like.

Still more alternatively, the control system 18 may even take this a step further and additionally perform also the analysis step in connection with manufacturing of the vehicle. In other words, the raw microphone data would not be stored locally or in a cloud storage, but rather the actual tuning or calibration setting of the audio system would be stored locally or in a cloud storage instead. In fact, these tuning or calibration settings are not particularly extensive in terms of storage requirement and could likely easily be stored locally on the vehicle.

The control system 18 would in such case perform the analysis step for a plurality of different positions within the total or maximal movement area 47 of the at least one microphone of the seat in the X-Z plane, as illustrated in FIG. 7, and upon later calibration request by a user or system, the control system 18 would simply select the predetermined tuning or calibration settings associated with a position in the X-Z plane that is located closest to the estimated or registered ear position of the current or most recent user of the vehicle.

A large number of predetermined tuning or calibration settings associated with a large number of different positions in the X-Z plane enables improved calibration process, because the discrepancy between the predetermined calibration location and the true location of the ear of the current or most recent user of the vehicle is likely smaller.

The basic steps of this alternative calibration method is described below with reference to FIG. 4E, which includes an initial step S10 of controlling the at least one powered seat position actuator, by the control system, for moving the at least one microphone of the vehicle seat to a plurality of different spatial positions covering a major portion, such as or example at least 50%, or at least 75%, of all conceivable seat positions, and registering, at each of said different spatial positions, microphone data received from the at least one microphone while generating a calibration sound by means of a loudspeaker of the vehicle audio system. The method further comprises a further initial step S13 of performing multiple calibrations for determining pre-determined calibration data for each of the plurality of different spatial positions covering the major portion of all conceivable seat positions. The method further comprises a subsequent step S15 of obtaining instructions or determining need for performing a calibrating of the vehicle audio system, and in response thereto, performing a final step S20 of applying said pre-determined calibration data associated with the spatial positions that is located as close as possible to, or overlapping, a registered or estimated position of an ear of user when seated in the vehicle seat, as viewed in a vehicle lateral direction.

In the method according to FIG. 4E, the initial steps S10 and S13 are typically performed at least in connection with manufacturing or delivering the vehicle, and subsequent steps S15 and S20 are generally performed after deliver to a user. The initial steps S10 and S13 may however be repeated sometimes after delivery to the user for updating the stored raw measurement data, for example once every year or the like.

In some example embodiments, the method for calibrating the audio system may further comprise storing a vehicle audio calibrating setting resulting from a calibration process and linking the stored vehicle audio calibrating setting with the current seat position; and subsequently applying said stored vehicle audio calibrating setting when the seat is moved to a position that has an audio setting linked thereto.

In other words, if a user performs a calibration process, and the seat upon start of the calibration process is located at a first position, the method will first perform the calibration process as described above, and additionally store a vehicle audio calibrating setting resulting from a calibration process and linking the stored vehicle audio calibrating setting with the current seat position. The control system is then configured to automatically apply said stored vehicle audio calibrating setting when the seat is moved to said first position, or adjacent to said first position, such as for example within +/−2 cm in the longitudinal direction X.

In some example embodiments, the method for calibrating the audio system further comprises storing a vehicle audio calibrating setting resulting from a calibration process and linking the stored vehicle audio calibrating setting with the current seat memory preset; and applying said stored vehicle audio calibrating setting when a memory preset is selected that has an audio setting linked thereto.

In other words, if a user first stores a certain seat position setting as number one of a memory seat function, and subsequently performs a calibration process, then the method will first perform the calibration process as described above, and additionally store a vehicle audio calibrating setting resulting from a calibration process and linking the stored vehicle audio calibrating setting with number one of a memory seat function. As a result, the control system will then be configured to automatically apply said stored vehicle audio calibrating setting when number one of the memory seat function is activated.

Finally, in still some other example embodiments, the method for calibrating the audio system may further comprises storing a vehicle audio calibrating setting resulting from a calibration process and linking the stored vehicle audio calibrating setting with a user identity; and applying said stored vehicle audio calibrating setting when a user having a user identify linked to an audio calibration setting is entering the seat.

In other words, if a user identity is registered by the vehicle, and said user subsequently performs a calibration process, then the method will first perform the calibration process as described above, and additionally store a vehicle audio calibrating setting resulting from a calibration process and linking the stored vehicle audio calibrating setting with said user identity. As a result, the control system will then be configured to automatically apply said stored vehicle audio calibrating setting when said user with the registered user identity is entering/starting the vehicle.

The one or more integrated microphones 17, 36 may also be used for other purposes, such as voice communication, voice commands, or Road Noise Cancellation. Consequently, in some example embodiments, the at least one microphone 17, 36 that is integrated in the seat headrest or upper region of the backrest may be used also for road noise cancellation, and/or voice communication, etc.

The present disclosure has been presented above with reference to specific embodiments. However, other embodiments than the above described are possible and within the scope of the disclosure. Different method steps than those described above, performing the method by hardware or software, may be provided within the scope of the disclosure.

The methods disclosed herein may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, or any other type of integrated circuit (IC).

The processor(s) associated with the control system may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure. Furthermore, modifications may be made to adapt a particular situation or material to the teachings of the present disclosure without departing from the essential scope thereof.

Although discussed above as methods described by the flowchart of FIGS. 4A-4E, it should be appreciated that one or more operations may be omitted from the methods discussed. Similarly, a single step of the flowcharts may include one or more activities, and the term “initial step” is not limited to being the first step, but merely a step in an initial phase of a method having a plurality of steps. Further, the operations may be performed in any order and do not necessarily imply an order as provided. Rather, the methods discussed are merely one embodiment of the present disclosure as contemplated.

### REFERENCE SIGNS

1. Vehicle
2. Front wheels
3. Rear wheels
4. Propulsion source
5. Passenger cabin
6. Front seats
7. Rear seats
8. Steering wheel
9 User
10. Seat cushion
11. Backrest
12. Headrest
13. Vehicle system
14. First loudspeaker
15. Second loudspeaker
16. Seat position actuator
17. Microphone
18. Control system
19. Vehicle audio system
20. Gateway arrangement
21. Seat control system
22. Audio controller (ECU)
23. Audio source
24. DSP
25. Power amplifiers
26. Initial seat position
27. First seat measurement position
28. Second seat measurement position
29. Third seat measurement position
30. Initial microphone position
31. First microphone measurement position
32. Second microphone measurement position
33. Third microphone measurement position
34. Pivot point
35. Seat position actuator
36. Second microphone
37. Centre position
38. Outer position
39 .Measurement area
40. Seat position actuator
41. Image detector
42. Dashboard
43. Predetermined length
44. Arrow
45. Estimated ear position
46. Angle
47. maximal area
48 Length of measurement area
49. Height of measurement area
50. Upper half portion of back seat
51. Area of headrest
52. Loudspeaker
53. Loudspeaker

What is claimed is:

1. A method for calibrating a vehicle audio system of a vehicle, wherein the vehicle comprises:
an audio system having a set of loudspeakers;
a power-adjustable vehicle seat including a seat cushion, a seat backrest, a seat headrest, at least one microphone integrated in the seat headrest or upper region of the backrest, and at least one powered seat position actuator for enabling adjustment of the vehicle seat position; and
a control system configured for controlling operation of the powered seat position actuator,
the method comprising:
controlling the at least one powered seat position actuator, by the control system, for moving the at least one microphone of the vehicle seat to a plurality of different spatial positions, and registering, at each of said different spatial positions, microphone data received from the at least one microphone while generating a calibration sound by means of a loudspeaker of the vehicle audio system; and
calibrating the vehicle audio system based on the registered microphone data received from the at least one microphone.

2. The method according to claim 1, wherein the step of calibrating the vehicle audio system involves calibrating the vehicle audio system based on the registered microphone data received from each of said plurality of different spatial positions,
wherein a relevance of said registered microphone data received from each of said plurality of different spatial positions are weighted differently when calibrating the vehicle audio system based on said registered microphone data.

3. The method according to claim 2, wherein the relevance of said registered microphone data received from each of said plurality of different spatial positions is weighted as a function of closeness of each of said plurality of different spatial positions, to a registered or estimated position of an ear of user when seated in the vehicle seat.

4. The method according to claim 1, wherein the method further comprises an initial step of obtaining instructions or determining need for performing a calibrating of the vehicle audio system, and in response thereto, initialising said steps of moving the at least one microphone of the vehicle seat to a plurality of different spatial positions and registering, at each of said different spatial positions, microphone data while generating a calibration sound by means of a loudspeaker.

5. The method according to claim 1, wherein the control of the at least one powered seat position actuator, for moving the at least one microphone of the vehicle seat to a plurality of different spatial positions, is based on at least one of the following parameters: position setting of the vehicle seat, position setting of the steering wheel, registered or estimated body length of a user, registered or estimated ear position of a user when seated in the vehicle seat.

6. The method according to claim 1, wherein the at least one powered seat position actuator is controlled, such that said plurality of different spatial positions, at which microphone data received from the at least one microphone is registered, are located as close as possible to, or overlapping, a registered or estimated position of an ear of user when seated in the vehicle seat, as viewed in a vehicle lateral direction.

7. The method according to claim 1, wherein said different spatial positions, at which microphone data received from the at least one microphone are registered, define a measurement area that is smaller than 50%, specifically smaller than 25%, more specifically smaller than 10%, of a maximal area reachable by said at least one microphone by control of the at least one powered seat position actuator, as viewed in a vehicle lateral direction.

8. The method according to claim 1, wherein the control system is configured to perform the calibration process of the vehicle audio system, including the motion of the at least one microphone of the vehicle seat to a plurality of different spatial positions and registering of microphone data received from the at least one microphone, automatically.

9. The method according to claim 1, wherein the control system is configured to perform the calibration process of the vehicle audio system, including the motion of the at least one microphone of the vehicle seat to a plurality of different spatial positions and registering of microphone data received from the at least one microphone, when the vehicle is empty of users and the vehicle doors and windows are closed.

10. The method according to claim 1, wherein the control system is configured to, prior to initialising said steps of moving the at least one microphone of the vehicle seat to a plurality of different spatial positions and registering, at each of said different spatial positions, microphone data while generating a calibration sound by means of a loudspeaker, requesting the user to leave the vehicle.

11. The method according to claim 1, wherein the step of calibrating a vehicle audio system based on the registered microphone data received from the at least one microphone involves:
analysing the received microphone data received from the at least one microphone; and
determining and applying a tuning profile to the signal of at least one output channel of the vehicle audio system.

12. The method according to claim 1, wherein the step of analysing the received microphone data received from the at least one microphone involves applying a correction for eliminating or at least reducing the acoustical effects caused by having the at least one microphone embedded into the seat.

13. The method according to claim 1, wherein the method comprises:
an initial step of controlling the at least one powered seat position actuator, by the control system, for moving the at least one microphone of the vehicle seat to a plurality of different spatial positions covering a major portion of all conceivable seat positions, and registering, at each of said different spatial positions, microphone data received from the at least one microphone while generating a calibration sound by means of a loudspeaker of the vehicle audio system; and upon obtaining instructions or determining need for performing a calibrating of the vehicle audio system, performing the calibrating of the vehicle audio system based on microphone data registered at those plurality of different spatial positions that are located as close as possible to, or overlapping, a registered or estimated position of an ear of user when seated in the vehicle seat, as viewed in a vehicle lateral direction, or
an initial step of controlling the at least one powered seat position actuator, by the control system, for moving the at least one microphone of the vehicle seat to a plurality of different spatial positions covering a major portion of all conceivable seat positions, and registering, at each of said different spatial positions, microphone data received from the at least one microphone while generating a calibration sound by means of a loudspeaker of the vehicle audio system; performing multiple calibrations for determining pre-determined calibration data for each of the plurality of different spatial positions covering the major portion of all conceivable seat positions; and upon obtaining instructions or determining need for performing a calibrating of the vehicle audio system, applying said pre-determined calibration data associated with the spatial positions that is located as close as possible to, or overlapping, a registered or estimated position of an ear of user when seated in the vehicle seat, as viewed in a vehicle lateral direction.

14. The method according to claim 1, wherein the at least one microphone that is integrated in the seat headrest or upper region of the backrest is used also for road noise cancellation, and/or voice communication.

15. A vehicle system comprising:
a vehicle audio system having a set of loudspeakers;
a power-adjustable vehicle seat including a seat cushion, a seat backrest, a seat headrest, at least one microphone integrated in the seat headrest or upper region of the backrest, and at least one powered seat position actuator for enabling adjustment of the vehicle seat position; and
a control system configured for controlling operation of the powered seat position actuator, wherein the control system is configured for:
controlling the at least one powered seat position actuator, by the control system, for moving the at least one microphone of the vehicle seat to a plurality of different spatial positions, and registering, at each of said different spatial positions, microphone data received from the at least one microphone while generating a calibration sound by means of a loudspeaker of the vehicle audio system; and
calibrating the vehicle audio system based on the registered microphone data received from the at least one microphone.
